(19) United States
(12) Patent Application Publication
(10) Pub. No.: US 2026/0187665 A1
(43) Pub. Date: Jul. 2, 2026

(54) COMPANY EVALUATION PROCESSOR SYSTEM

(71) Applicant: Hitachi, Ltd., Tokyo (JP)

(72) Inventors: Yuki YOSHII, Tokyo (JP); Motonobu SAITO, Tokyo (JP)

(21) Appl. No.: 18/878,185

(22) PCT Filed: Apr. 18, 2023
(86) PCT No.: PCT/JP2023/015403

§ 371 Date: Dec. 23, 2024

(30) Foreign Application Priority Data
Aug. 29, 2022 (JP) 2022-135510

(51) Int. Cl. G06Q 30/0203

(52) U.S. Cl. CPC G06Q 30/0203

(57) ABSTRACT

The burden of answering questions regarding a supplier in a company evaluation is eased by a company evaluation processor system that includes a memory that stores, for each predetermined target company, master data in which at least one or more questions are associated with an answer, and stores a predetermined score allocation for each question in the master data for each evaluation company. The system receives a questionnaire acquired by the target company from a questionnaire distribution source and a questionnaire answer, when any of the questionnaire questions and any of the questions in the master data related to the target company are similar to each other. The questionnaire answer is stored in the memory as the answer in the master data related to the target company, and the answer in the master data of the target company is scored using the score allocation according to the evaluation company.

### TECHNICAL FIELD

The present invention relates to a company evaluation processor system. The invention claims the priority of Japanese Patent Application No. 2022-135510 filed on Aug. 29, 2022, and the contents described in the application are incorporated into the present application by reference in the designated country where incorporation by reference of literatures is permitted.

### BACKGROUND ART

In recent years, environment, social, governance (ESG) investment market has been expanding. In an ESG investment market, investors evaluate companies based on ESG factors and determine where to invest. This is because a company that places importance on ESG is expected to be stable in future management and is highly likely to grow.

In recent years, an evaluation of ESG including environmental problems, child work problems, and the like has been conducted not only for the company but also for an entire supply chain. Therefore, buyers are increasingly requesting an ESG evaluation of a business subject (also referred to as a supplier) participating in a supply chain system.

In a supplier ESG evaluation for such a buyer, information is mainly obtained by conducting questionnaire surveys on the supplier.

On the other hand, for the supplier, answering the questionnaire survey is a heavy burden. This is because the number of questions may be several tens to hundreds, and some questions may require attachment of evidence data as an evidence to answers. A plurality of evaluation organizations are present, each with similar, but not exactly identical, questions. Further, in addition to a questionnaire from the evaluation organization, a buyer may create a unique question and request an answer from the supplier. As a result, an answer rate from the supplier tends to be low.

A buyer can make a contract with a specific evaluation organization to utilize an evaluation result of a supplier with which the buyer does business. However, there are not many cases where all suppliers do business participate in an evaluation scheme of the evaluation organization. Therefore, a buyer evaluates a supplier by using a plurality of evaluation organizations in combination, or using questions created independently by the buyer in combination.

Questions in the questionnaire tend to share many of same underlying standards as ISO (International Organization for Standardization) 26000, ISO 14000 series, the United Nations Global Compact, and the like, and differences in the questions are often due to differences in resolution. Questionnaires often share the same underlying criteria, but there are often differences in a way the questions are asked. For example, depending on the questionnaire, there may be differences between asking whether goals are set and asking about results of achieving those goals.

In view of such a background, in the related art from a viewpoint of ESG evaluation, PTL 1 quantitatively collects ESG information in a specific company as data and outputs information based on the data. That is, PTL 1 discloses a technique that quantitatively analyzes ESG data and visualizes a result thereof to support ESG management in a company.

In a field of natural language processing, a feature extraction method such as Bag of Words, TF-IDF, BM-25, and N-gram is generally known as a recognition technique of commonality of sentences.

There are a large number of machine learning techniques, and in particular, a Support Vector Machine, a decision tree, a k-nearest neighbor algorithm, and the like are generally known as techniques that are often used as a classifier in natural language processing.

As a related art for the natural language processing, there is a question type learning device that configures a highly accurate classifier for question type identification using N-gram, a natural language processing technique, and a Support Vector Machine, a machine learning technique, as disclosed in PTL 2.

### CITATION LIST

### Patent Literature

PTL 1: JP2021-009696A
PTL 2: JP2004-094521A

### SUMMARY OF INVENTION

### Technical Problem

In the technique described in PTL 1, it is possible to collect ESG information on an evaluation target company from a core system of the evaluation target company and conduct a quantitative ESG evaluation. However, in an environment where it is common for each evaluation organization to conduct its own questionnaire as described above, such a mechanism cannot be used as it is. An answer to a questionnaire question is not necessarily based on a numerical value, and there is a case where it is necessary to receive a result of various data and make an answer including a sentence using a natural language. When an answer using quantitative data is required, it may be necessary to process the acquired quantitative data to match the questions of the evaluation organizations or buyers and create an answer. The question includes a qualitative question, and data necessary for the answer is not limited to quantitative data. In order to answer the questionnaire, it is necessary to organize collected enormous amount of information into an appropriate form as an answer to the question and write down the information as an answer to the question.

An object of the invention is to reduce a burden of answering on a supplier in a company evaluation.

### Solution to Problem

The present application includes a plurality of units for solving at least a part of the above problems, and examples thereof are as follows. A system according to one aspect of the invention that solves the above problems is a company evaluation processor system including: one or more memories; and one or more processors, in which the memory stores, for each predetermined target company, master data in which at least one or more questions are associated with an answer to the question, and stores a predetermined score allocation associated with each question in the master data for each evaluation company that evaluates the target company, and the processor receives a questionnaire acquired by the target company from a questionnaire distribution source and a questionnaire answer, which is an answer of the target company to a questionnaire question that is one or more questions in the questionnaire, when any of the questionnaire questions and any of the questions in the master data related to the target company are similar to each other, stores the questionnaire answer in the memory as the answer in the master data related to the target company, and scores the answer in the master data of the target company using the score allocation according to the evaluation company to evaluate the target company and output the evaluation.

### Advantageous Effects of Invention

According to the invention, it is possible to provide a technique of reducing a burden of answering on a supplier in a company evaluation. Problems, configurations, and effects other than those described above will become apparent in the following description of the embodiment of the invention.

### BRIEF DESCRIPTION OF DRAWINGS

FIG. 1 is a diagram showing a configuration example of a question-answer and evaluation system.

FIG. 2 is a diagram showing an example of answer complementation based on evidence data.

FIG. 3 is a diagram showing another example of the answer complementation based on the evidence data.

FIG. 4 is a diagram showing an example of a flowchart of answer support processing.

FIG. 5 is a diagram showing a data structure example of a question material storage area.

FIG. 6 is a diagram showing a data structure example of an answer history storage area.

FIG. 7 is a diagram showing a data configuration example of a master data storage area.

FIG. 8 is a diagram showing a data configuration example of master data.

FIG. 9 is a diagram showing an example of a flowchart of company evaluation processing.

FIG. 10 is a diagram showing another example of the flowchart of the answer support processing.

FIG. 11 is a diagram showing an example of an inter-company evaluation.

FIG. 12 is a diagram showing an example of performing factor analysis using master data.

FIG. 13 is a diagram showing an example of a hardware structure of a processor system.

### DESCRIPTION OF EMBODIMENTS

Hereinafter, an embodiment according to the invention will be described with reference to the drawings. The embodiment is an example illustrating the invention, and is omitted and simplified as appropriate for clarity of description. The invention can be implemented in various other aspects. Unless otherwise specified, each component may be single or plural.

In order to facilitate understanding of the invention, the position, size, shape, range, and the like of each component shown in the drawings may not represent the actual position, size, shape, range, and the like. Therefore, the invention is not necessarily limited to the position, size, shape, range, or the like disclosed in the drawings.

As examples of various types of information, expressions such as “table”, “list”, and “queue” may be used for description, but the various types of information may be expressed in a data structure other than these described. For example, various types of information such as “XX table”, “XX list”, and “XX queue” may be “XX information”. In describing identification information, when expressions such as “identification information”, “identifier”, “name”, “ID”, and “number” are used, the expressions can be replaced with one another. The identification information described in this expression is expressed by using a symbol, a numerical value, a natural language, or combination thereof in the embodiment, but the identification information may be in other formats.

When there are a plurality of components having the same or similar functions, the same reference signs may be assigned with different subscripts. When it is not necessary to distinguish the plurality of components, the description may be made by omitting the subscripts.

In the embodiment, processing performed by executing a program may be described. Here, a computer executes the program by a processor (for example, a CPU or a GPU) and performs processing defined by the program using a storage resource (for example, a memory), an interface device (for example, a communication port), or the like. Therefore, a subject of the processing performed by executing the program may be the processor. Similarly, the subject of the processing performed by executing the program may be a controller, a device, a system, a computer, or a node including a processor. The subject of the processing performed by executing the program may be a calculation unit and may include a dedicated circuit that executes specific processing. Here, the dedicated circuit is, for example, a field programmable gate array (FPGA), an application specific integrated circuit (ASIC), a complex and programmable logic device (CPLD).

The program may be installed in the computer from a program source. The program source may be, for example, a program distribution server or a computer-readable storage medium. When the program source is the program distribution server, the program distribution server may include a processor and a storage resource for storing a program to be distributed, and the processor of the program distribution server may distribute the program to be distributed to another computer. In the embodiment, two or more programs may be implemented as one program, or one program may be implemented as two or more programs.

Although the invention is a processor system, the invention may be implemented as a platform having functions of the invention.

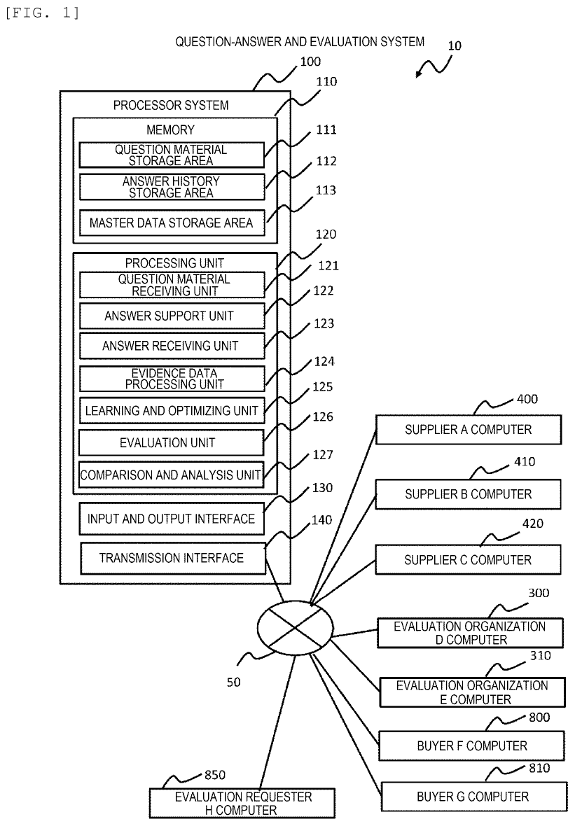

FIG. 1 is a diagram showing a configuration example of a question-answer and evaluation system. For example, a question-answer and evaluation n system 10 is a company evaluation system including a processor system 100, a network 50, an evaluation organization D computer 300, an evaluation organization E 310, computer a supplier computer 400, a supplier B computer 410, a supplier C computer 420, a buyer F computer 800, a buyer G computer 810, and an evaluation requester H computer 850.

The network 50 is, for example, any one of a local area network (LAN), a wide area network (WAN), a virtual private network (VPN), a communication network in which a general public line such as the Internet is partially or entirely used, a mobile phone communication network, or a composite network thereof. The network 50 may be a wireless communication network such as Wi-Fi (registered trademark) or 5 generation (G).

An evaluation organization D and an evaluation organization E are examples of an organization that evaluates suppliers that are subjects that provide components and products, in a component supply network such as a supply chain network. The evaluation organizations are not limited to only two organizations, and usually there are more organizations. However, in the example of the present embodiment, in order to simplify the description, these two organizations are referred to as evaluation organizations.

A supplier A, a supplier B, and a supplier C are examples of a supplier that is a subject that provides components and products in a component supply network such as a supply chain network. The suppliers are not limited to only three organizations, and usually there are more organizations. However, in the example of the present embodiment, in order to simplify the description, these three organizations are referred to as suppliers.

A buyer F and a buyer G are examples of a buyer that is a subject that purchases components and products in a component supply network such as a supply chain network. The buyers are not limited to only two organizations, and usually there are more organizations. However, in the example of the present embodiment, in order to simplify the description, these two organizations are referred to as buyers. When managing and selecting a supplier, a buyer may use the evaluation organization, or may evaluate the supplier by self without using the evaluation organization. In the example of the present embodiment, a supplier and a buyer are distinguished from each other for simplicity of description. However, when the supplier purchases a component or a product, the supplier may also be a buyer, and when another buyer purchases a component or a product provided by the buyer, the buyer may also be a supplier.

An evaluation requester H is an example of an evaluation requester that requests the processor system to evaluate a supplier for the purpose of managing and selecting the supplier. The evaluation requester may be, for example, a buyer, but may also be a party other than a buyer, such as an investor. In the example of the present embodiment, the evaluation requester and the buyer are distinguished from each other in order to simplify the description, but the buyer may be the evaluation requester as described above.

Further, using some or all of the functions of the processor system, a company having a plurality of affiliated companies can evaluate and manage sustainability of the company. In this case, it is conceivable to conduct an internal ESG evaluation of a company by treating the company as the evaluation requester H and treating the affiliated company of the company as the supplier.

The processor system 100 includes a memory 110, a processing unit 120, an input and output interface 130, and a transmission interface 140. The memory 110 includes a question material storage area 111, an answer history storage area 112, and a master data storage area 113. The processing unit 120 includes a question material receiving unit 121, an answer support unit 122, an answer receiving unit 123, an evidence data processing unit 124, a learning and optimizing unit 125, an evaluation unit 126, and a comparison and analysis unit 127. The processor system 100 is a system including one or more processors. The processor system 100 may also be referred to as a company evaluation processor system.

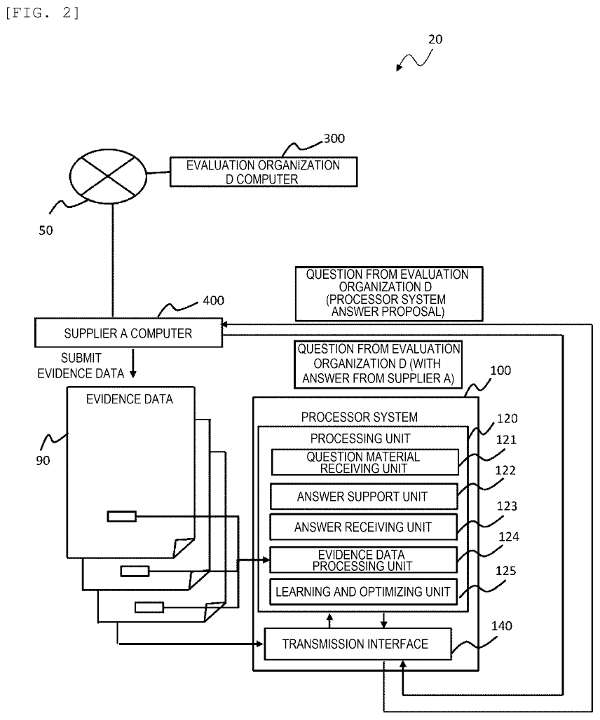

FIG. 2 is a diagram showing an example of answer complementation based on evidence data by the evidence data processing unit 124, among functions of the processor system 100. For a documentary evidence or data that is a basis of the answer, expressions such as “evidence data” and “documentary evidence” are used, the expressions are interchangeable. At this time, two patterns are conceivable for the answer support processing. One is a pattern in which the processor system 100 receives a question material from an evaluation organization or a buyer, which is called a survey agency. The other is a pattern in which the processor system 100 receives a question material from a supplier, which is called answerer assistance. A difference between the two is whether the processor system 100 substitutes for operations from receiving the question material to conducting a survey and sending the answer or whether the supplier independently performs these operations. Even if there is such a difference in the methods, the question-answer and evaluation system 10 can reduce a burden of answering on the supplier. The example of answer complementation based on the evidence data shown in the figure is an example in which the answer is complemented by the answer support processing (answerer assistance). An outline of answerer assistance processing will be described with reference to FIG. 2. For simplification of the drawing, only functions necessary for the processing unit in FIG. 2 are illustrated, but the processing unit in FIG. 2 actually includes the configuration illustrated in FIG. 1.

First, the supplier A receives, from the evaluation organization D via the network 50, a request to answer a question material issued by the evaluation organization D. Specifically, the supplier A computer 400 receives a question material of the evaluation organization D from the evaluation organization D computer 300.

The supplier A sends, to the processor system 100, the evidence data for a question that requires evidence data in the question material and the question material. Specifically, the evidence data 90 is sent to the processor system 100 from the supplier A computer 400. At this time, the supplier A does not provide an answer to the question in the question material that requires evidence data for the answer. Even when attachment of the evidence data is not requested as the answer to the question, for the question for which answer information can be obtained based on the evidence data, similar processing can be performed by attaching the evidence data.

The processor system 100 receives the evidence data 90 and the question material through the transmission interface 140. Then, the question material receiving unit 121 of the processing unit 120 receives the question material, and the evidence data processing unit 124 receives the evidence data 90. Next, the evidence data processing unit 124 performs predetermined processing on the evidence data 90 to create an answer proposal for the question to which the evidence data 90 is attached, in the question material.

Here, for example, it is assumed that a portion of the evidence data 90 (a position in the evidence data) to be used as an answer to the question is specified in advance by the learning and optimizing unit 125. In this case, when the evidence data processing unit 124 receives the evidence data 90, the evidence data processing unit 124 extracts data in the portion and generates an answer to the question.

Alternatively, when the learning and optimizing unit 125 prepares in advance an answer proposal corresponding to description contents of the portion of the evidence data 90 to be used for the answer, the evidence data processing unit 124 selects an answer proposal most suitable for the description content of the evidence data 90 and creates an answer to the question.

Even when a question is not open-ended but a question that is answered by selecting from options, the evidence data processing unit 124 can similarly create an answer to the question. For example, when the learning and optimizing unit 125 prepares in advance which of the options is to be selected according to the description content of the portion of the evidence data 90 to be used for the answer, the evidence data processing unit 124 selects options most suitable for the description content of the evidence data 90 and creates the answer to the question. For example, if the evidence data 90 contains data with an appropriate title and data type, the evidence data processing unit 124 selects an option of “initiatives are being implemented” as an answer to the question.

Alternatively, when a question requires a numerical answer as well, the evidence data processing unit 124 can similarly create an answer to the question. For example, when the evidence data 90 is a comma separated value (CSV) file in which a numerical value is described, the evidence data processing unit 124 reads the CSV file, extracts one or a plurality of portions necessary for an answer, and uses the extracted portions as input variables of predetermined four arithmetic operations to perform calculation to create an answer to the question. In this case, the learning and optimizing unit 125 stores in advance positions of rows and columns required for creating an answer, formulas required for calculation, and the like, and by executing contents thereof, an answer to a question is created. The positions of rows and columns required for creating an answer, the formulas required for calculation, and the like are stored in the learning and optimizing unit 125 using past answer contents, assuming that the positions of rows and columns required for creating an answer, the formulas required for calculation, and the like are basically unchanged from the previous year. The evidence data processing unit 124 may extract a plurality of pieces of data read at a predetermined position in a data set and use the plurality of pieces of data as input variables, and may also use external data collected by Web crawling processing as an input variable to perform a calculation using a predetermined calculation formula and use a result to complement a questionnaire answer.

The answer support unit 122 records the created answer as an answer to the question material, and sends the answer to the supplier A computer 400 via the transmission interface 140. Further, the supplier A having received the answer proposal from the processor system 100 adds a necessary correction to the input answer proposal, and sends the question material of the evaluation organization D with a completed answer to the processor system 100 again. The sent material is received by the answer receiving unit 123 of the processing unit 120 via the transmission interface 140, and the learning and optimizing unit 125 is updated in relation to whether the answer is corrected and a correction content. That is, the learning and optimizing unit 125 performs machine learning using presence or absence of correction to the questionnaire answer and corrected answer information, and constructs a trained model of the supplier A (for each target company).

The supplier A computer 400 sends the question material of the evaluation organization D with the completed answer and the evidence data to the evaluation organization D computer 300. When the answer proposal is corrected, there is a high possibility that the answer proposal extracted from the evidence data is wrong. In this case, the learning and optimizing unit 125 needs to change a reference portion of the evidence data 90 or a calculation formula. Therefore, the learning and optimizing unit 125 re-trains a format of the evidence data 90, the calculation formula, or basis data collected by Web crawling.

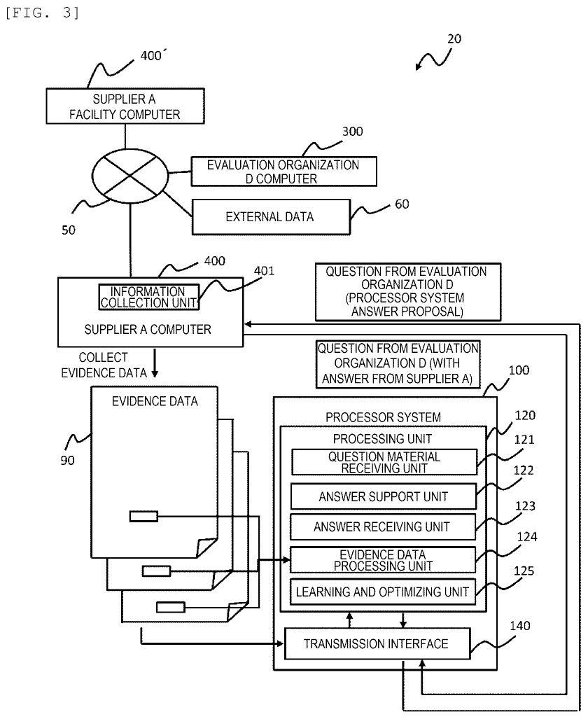

FIG. 3 is a diagram showing another example of the answer complementation based on the evidence data by the evidence data processing unit 124 among the functions of the processor system 100. In this example, the evidence data 90 is not attached to the supplier A, and the processor system 100 collects information collected by an information collection unit 401 of the supplier A computer 400. Specifically, the information collection unit 401 collects in advance numerical data of a monitoring target from each facility, equipment (for example, the supplier A facility computer 400′ in FIG. 3), or the like owned by the supplier. Alternatively, the information collection unit 401 obtains Web information in advance by performing Web crawling or the like. The evidence data processing unit 124 collects the evidence data 90 collected by the information collection unit 401 at a timing of answer support.

Further, in FIG. 3, the evidence data processing unit 124 acquires external data 60 when there is a shortage of the external data 60 for the four arithmetic operations to calculate the answer. The external data 60 is, for example, an emission intensity used for calculating a CO₂ emission amount. More specifically, numerical data to be monitored from facilities, equipment, and the like owned by a supplier corresponds to electric power consumption in a target year. The evidence data processing unit 124 calculates the CO₂ emission amount by multiplying the electric power consumption by the emission intensity of power, which corresponds to the external data 60.

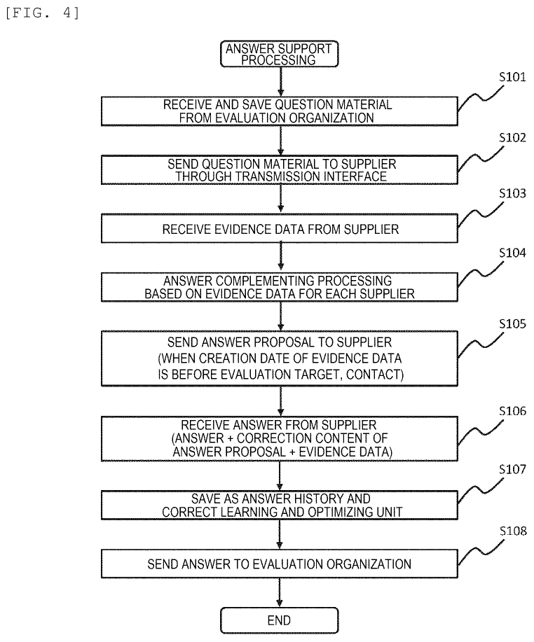

FIG. 4 is an example of a process flow of the answer support processing (survey agency). The answer support processing (survey agency) is started when a start instruction is received from an evaluation organization, a buyer, or the like. Alternatively, the answer support processing (survey agency) may be started at a predetermined date and time (for example, 6 a.m. every day) or at predetermined intervals (for example, every 12 hours). The answer support processing (survey agency) is performed when the processor system 100 substitutes for operations from receiving the question material to conducting a survey and sending an answer.

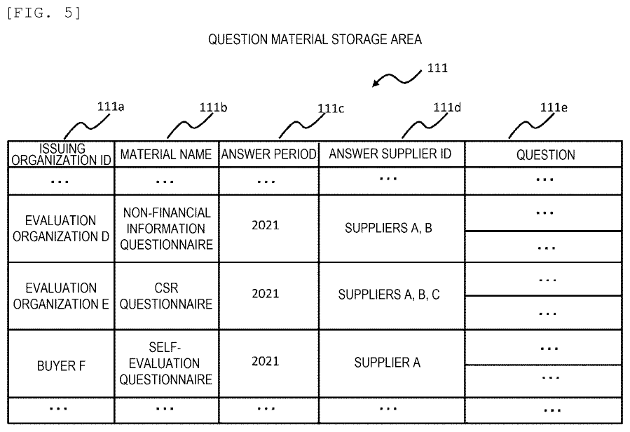

First, the question material receiving unit 121 receives a question material from an evaluation organization or a buyer and saves the question material (step S101). Specifically, the question material receiving unit 121 receives the question material from the evaluation organization D computer 300, the evaluation organization E computer 310, the buyer F computer 800, and the buyer G computer 810. The question material receiving unit 121 breaks down the received question material into question units, reconstructs the question material, and stores the question material in the question material storage area 111 (FIG. 5).

The answer support unit 122 then sends the question material to the supplier through the transmission interface 140 (step S102).

The evidence data processing unit 124 receives a documentary evidence or data from the supplier (step S103). Specifically, the evidence data processing unit 124 receives, from the supplier A computer 400, the supplier B computer 410, and the supplier C computer 420, a documentary evidence or data (which may be collectively referred to as a data set) related to an answer to the question.

If a creation date of the data set received in step S103 is before an evaluation target period, the evidence data processing unit 124 determines that the data set is insufficient as a documentary evidence or data, and displays a message to that effect on a computer of the supplier.

Then, the answer support unit 122 uses the sent data set to perform answer complementing processing (step S104). Specifically, as described above, the answer support unit 122 reads and transcribes one or more pieces of data at a predetermined position of the sent data set to complement a questionnaire answer. When there is master data for the same supplier that is already answered to another questionnaire, the answer support unit 122 complements an answer in the master data as an answer to a questionnaire question, if a question similar to any of questions in the master data does not contain an answer. The answer support unit 122 uses a trained model of the learning and optimizing unit 125 in processing of complementing the answer to the questionnaire related to the same supplier but with different survey periods or different questionnaire distribution sources.

Then, the answer support unit 122 sends an answer proposal to the supplier (step S105).

The answer receiving unit 123 receives an answer from the supplier (step S106). Specifically, the answer receiving unit 123 receives an answer, a documentary evidence or data, and a correction content of the answer proposal from the supplier A computer 400, the supplier B computer 410, and the supplier C computer 420.

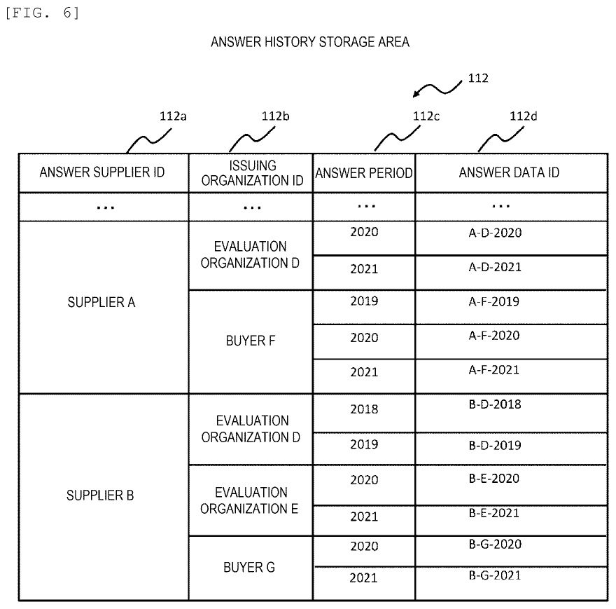

The learning and optimizing unit 125 saves the received answer as an answer history in the answer history storage area 112 (step S107) (FIG. 6). The learning and optimizing unit 125 analyzes a correction content of the answer proposal, and corrects a program that describes a procedure of creating the answer based on the documentary evidence or the data and a classifier of the learning and optimizing unit 125.

The answer support unit 122 sends an answer received from the supplier to the evaluation organization or the buyer that requested the survey (step S108). Specifically, the answer support unit 122 sends the answer received from the supplier through the transmission interface 140 to the evaluation organization D computer 300, the evaluation organization E computer 310, the buyer F computer 800, and the buyer G computer 810.

The above is an example of the flowchart of the answer support processing (survey agency). According to the answer support processing (survey agency), it is possible to reduce a burden of answering to the question. Therefore, it is possible to reduce a burden of answering on a supplier in a company evaluation.

FIG. 5 is a diagram showing a data structure example of the question material storage area. The question material storage area 111 stores information on a question for a supplier. Specifically, the question material storage area 111 includes an issuing organization ID 111a, a material name 111b, an answer period 111c, an answer supplier ID 111d, and a question 111e. The issuing organization ID 111a, the material name 111b, the answer period 111c, the answer supplier ID 111d, and the question 111e are associated with each other.

The issuing organization ID 111a stores information for specifying an issuing organization ID, which is identification information for specifying an issuing organization of the question. In the present embodiment, in a case of a non-financial information questionnaire or a CSR questionnaire, the issuing organizations are the evaluation organization D and the evaluation organization E, and in a case of self-evaluation questionnaire (SAQ), or the like, the issuing organization is the buyer F. However, there may be a case where a self-evaluation questionnaire is provided from an evaluation organization, and there may be a case where a non-financial information questionnaire or a CSR questionnaire is issued from a buyer.

The material name 111b stores a material name of a material in which a question is written. The material name may be different for each issuing organization, and in the present embodiment, the material name is a “non-financial information questionnaire”, a “corporate social responsibility (CSR) questionnaire”, a “self-evaluation questionnaire”, or the like. However, the invention is not limited to this, and it is generally sufficient to request an answer to non-financial information such as ISO 26000 or ISO 14000 series. Most of the materials include questions issued from an evaluation organization or a buyer with a supplier as an answerer.

The answer period 111c includes information for specifying a period during which a material in which the question is written is to be answered. Since many evaluation organizations cause suppliers to answer with a result of a previous year at a frequency of once a year, information specifying the previous year is stored in the answer period 111c. However, when question materials are issued at different frequencies, the answer period 111c stores information for specifying a period (first half, second half, first quarter, etc.) corresponding to an answer period.

The answer supplier ID 111d stores information for specifying a subject that makes an answer to the material specified by the material name 111b.

The question 111e stores a question sentence (natural language, index, or mathematical formula) in the material specified by the material name 111b. In FIG. 5, there are two questions for simplification of the drawing, but there are actually several questions to several hundreds of questions.

FIG. 6 is a diagram showing a data structure example of the answer history storage area. The answer history storage area 112 stores answer data of a supplier for each issuing organization and each answer period. Specifically, the answer history storage area 112 includes an answer supplier ID 112a, an issuing organization ID 112b, an answer period 112c, and an answer data ID 112d. The answer data identified by the answer data ID 112d includes the answer data finally answered to the issuing organization and the attached evidence data. However, when there are some answers such as resubmission during the same period, the answer data 112d may include an answer history.

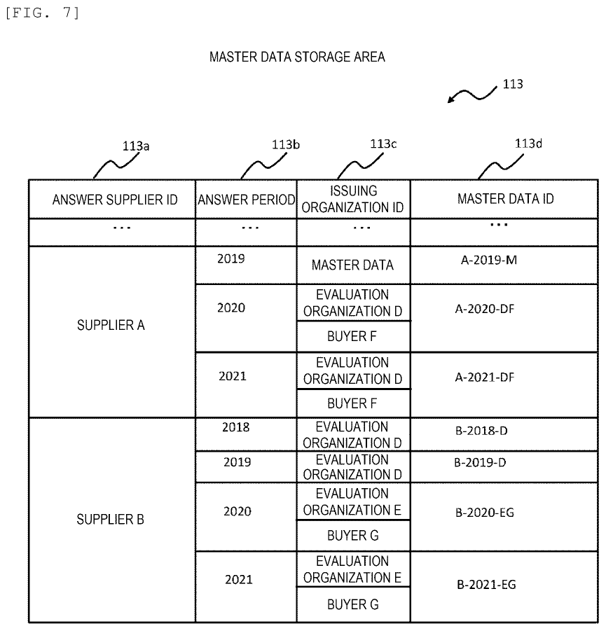

FIG. 7 is a diagram showing an example of the master data storage area. The master data storage area 113 includes an answer supplier ID 113a, an answer period 113b, an issuing organization ID 113c, and a master data ID 113d.

The answer supplier ID 113a stores information for specifying a subject that makes an answer. The answer period 113b includes information specifying a period during which a material to be is answered. The issuing organization ID 113c stores information for specifying an issuing organization ID, which is identification information for specifying an issuing organization of the question. The master data ID 113d includes information for specifying master data, which is to be described later, created for each supplier in each answer period 113b.

The master data storage area 113 stores, for each supplier, a relationship between the master data ID 113d created in each answer period 113b and the issuing organization ID 113c of the evaluation organization or the buyer that sets the question used in creating the master data ID. For example, the master data ID 113d, whose answer period 113b is “2019” for a record whose the answer supplier ID 113a is “supplier B”, is created based on an answer to a question created by an organization in which the issuing organization ID 113c is “evaluation organization D”.

The master data ID 113d whose answer period 113b is “2019” for a record whose answer supplier ID 113a is “supplier A” has an issuing organization ID 113c set to “master data”. This indicates that the master data related to the record is not an answer to a question issued by an external organization such as an evaluation organization or a buyer, but is a direct answer to a question of the master data itself.

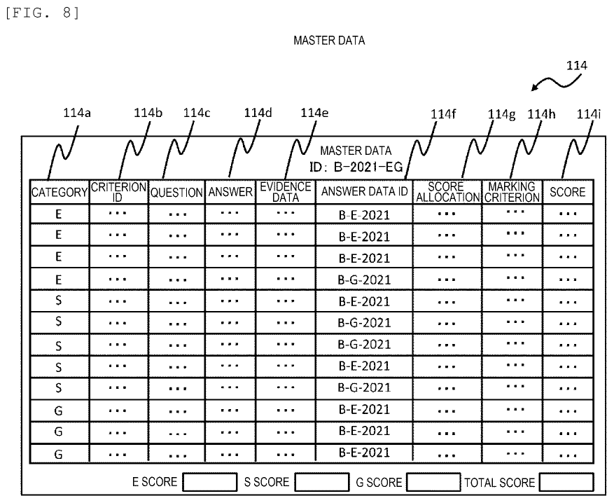

FIG. 8 is a diagram showing a data configuration example of master data. Master data 114 exists for each supplier and for each answer period. The master data 114 is data in which a category 114a, a criterion ID 114b, a question 114c, an answer 114d, evidence data 114e, an answer data ID 114f, a score allocation 114g, a marking criterion 114h, and a score 114i are associated with one another. The category 114a indicates a category to which the question 114c belongs. For example, a category “E” is a category related to Environment. The criterion ID 114b is information associated one-to-one with a feature vector of a question that is a criterion. The question 114c is a question from an evaluation organization or a buyer having a feature vector corresponding to the criterion ID 114b. The answer 114d is an answer from a supplier that is logarithmic to the question specified by the question 114c.

The evidence data 114e is information for specifying data as evidence associated with the answer 114d. The answer data ID 114f is the same as the answer data ID 112d in the answer history storage area 112, and is associated with a question and an answer from an evaluation organization or a buyer.

The score allocation 114g is a score allocation for quantitatively evaluating the answer 114d. The marking criterion 114h is a marking criterion for quantitatively evaluating the answer 114d. The score 114i is a score as a result of quantitatively evaluating the answer 114d. Setting of the score e allocation 114g and the marking criterion 114h is set for each answer period by an evaluation requester. Therefore, the score allocation 114g and the marking criterion 114h can be set in common to all evaluation target suppliers. It is also possible to divide the suppliers into specific groups, for example, groups based on business areas or company sizes, and set the score allocation 114g and the marking criterion 114h for each group.

The master data 114 is obtained by associating a question and an answer when a supplier answers a question from one or more evaluation organizations or buyers in an answer period with the criterion ID 114b associated with a criterion question. That is, if questions from the evaluation organization or the buyer contain a question that asks the same content as the criterion question, the question and an answer thereof are associated with the question 114c and the answer 114d, respectively, in a row of the criterion ID 114b associated with the criterion question. On the other hand, if there is no question from the evaluation organization or the buyer that asks the same content as the criterion question, the question 114c and the answer 114d in the row of the criterion ID 114b are blank.

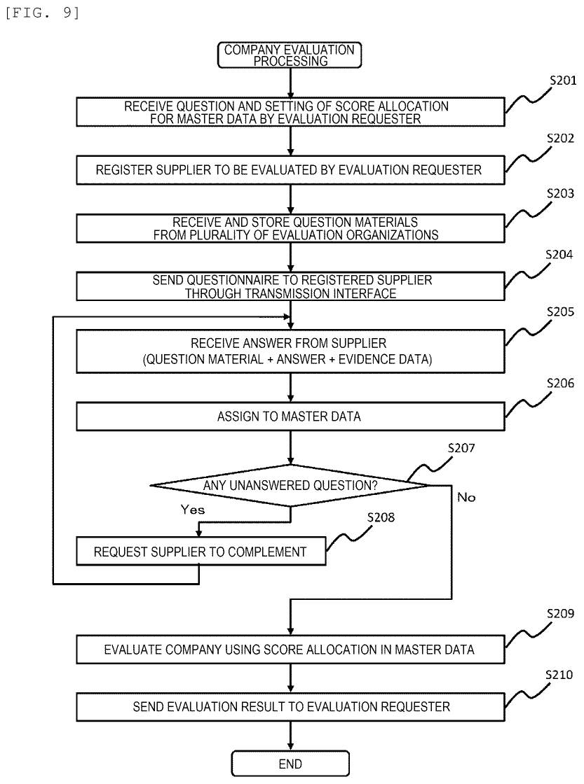

FIG. 9 is a diagram showing an example of a flowchart of company evaluation processing. The company evaluation processing is processing in which questionnaires provided by a plurality of evaluation organizations and questionnaires independently created by buyers are classified according to contents of the questions, and the same questions are aligned side by side, thereby integrating and displaying the plurality of questionnaires. In the company evaluation processing, an evaluation between supplier companies can be shown in comparison by using the score allocations and the marking criterion assigned in advance in master data. The company evaluation processing is started when a start instruction is received from an evaluation organization, or a buyer, the like.

Alternatively, the company evaluation processing may be started at a predetermined date and time (for example, 6 a.m. every day) or at predetermined intervals (for example, every month).

First, the evaluation unit 126 receives a question and setting of a score allocation for master data for a corresponding year stored in the master data storage area 113 in the memory 110, from an evaluation requester (evaluation requester H computer 850) (step S201).

The supplier may not always answer a question desired by the evaluation requester, for example, the supplier may answer a questionnaire from an evaluation organization different from the evaluation requester. Therefore, by allowing the evaluation requester to set a score allocation for a question in the master data, it is possible to evaluate answers to different questionnaires using the same criterion. Specifically, the evaluation unit 126 receives setting of a score allocation and a marking criterion in the master data 114. At this time, the score allocation and the marking criterion in the master data 114 can be freely set by the evaluation requester. However, in consideration of a time and effort required to set all score allocations and evaluation criteria, the evaluation unit 126 may receive a selection from score allocation proposals stored in advance in the memory 110 of the processor system 100 according to needs of the evaluation requester. The question for which a score allocation is set to 0 is excluded from evaluation items assuming that the question is not a question for a corresponding year.

The evaluation unit 126 receives registration of a supplier to be evaluated by the evaluation requester (step S202). Specifically, the evaluation unit 126 receives a selection of an answer supplier, which is an evaluation target, from the answer supplier ID 113a in the master data storage area 113.

Then, the question material receiving unit 121 receives question materials from a plurality of evaluation organizations or buyers and saves the question materials (step S203). Specifically, the question material receiving unit 121 receives the question material from the evaluation organization D computer 300, the evaluation organization E computer 310, the buyer F computer 800, and the buyer G computer 810. The question material receiving unit 121 breaks down the received question material into question units, reconstructs the question material, and stores the question material in the question material storage area 111.

The question material receiving unit 121 sends a question material to the supplier registered in step S202 through the transmission interface 140 (step S204). Specifically, the question material receiving unit 121 sends question materials received from the evaluation organization D computer 300, the evaluation organization E computer 310, the buyer F computer 800, and the buyer G computer 810 to the supplier. The question material receiving unit 121 also sends a question material received from an evaluation organization or a buyer to a supplier that is not registered as an evaluation target by any of evaluation requesters. Only an answer content of the supplier registered as a target to be evaluated by the evaluation requester is used for an evaluation of the evaluation requester.

The answer receiving unit 123 receives an answer from the supplier (step S205). Specifically, the answer receiving unit 123 receives the question material, the answer, and a documentary evidence or data from the supplier A computer 400, the supplier B computer 410, and the supplier C computer 420.

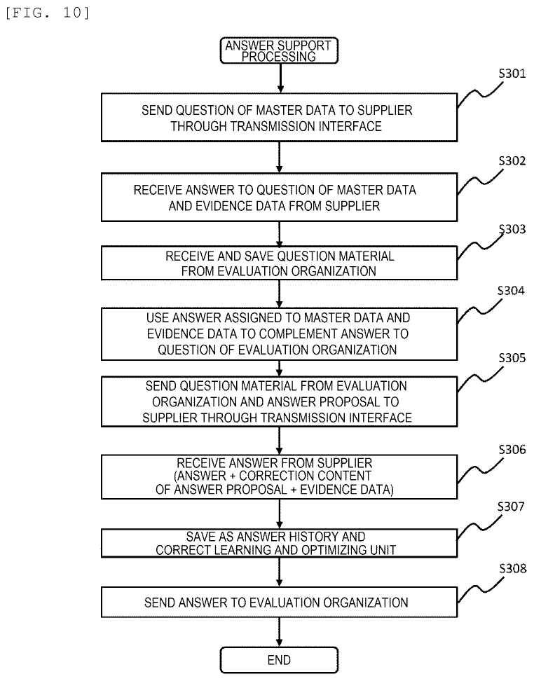

Between step S204 and step S205 in which the supplier answers the question from the evaluation organization or the buyer or the question 114c of the master data 114, the answer receiving unit 123 may receive the answer by manual input, or may use answer complementation using the documentary evidence or the data by the answer support processing. Alternatively, both of the operations may be performed. An example of processing of performing the answer complementation will be described later with reference to FIG. 10.

Specifically, the answer receiving unit 123 stores, in the answer history storage area 112 for each supplier, an evaluation organization or a buyer that receives evaluations from past to present, an answer period in which the evaluation is conducted, and answer data at the time of the evaluation, in association with each other. For example, the supplier A is evaluated by the evaluation organization D in answer periods 2020 and 2021. The answer receiving unit 123 stores an answer data ID of data in the answer period 2020 as “A-D-2020” and an answer data ID of data in the answer period 2021 as “A-D-2021”. The answer data ID is associated with stored actual question and answer data for the question.

The answer receiving unit 123 breaks down the received question material, answer, and documentary evidence or data into question units, reconstructs the question material, answer, and documentary evidence or data, and stores the question material, answer, and documentary evidence or data in the master data 114 of a corresponding year stored in the master data storage area 113 (step S206). At this time, the answer receiving unit 123 stores the received question material, answer, and documentary evidence or data serving as an original of the data in a predetermined area of the memory.

As a method of associating a question having the same content as a question associated with the criterion ID 114b of the master data 114, for example, a method of obtaining a question from an evaluation organization or a buyer in advance and manually associating the questions may be used.

Alternatively, when a question material is sent from an evaluation organization, a buyer, or a supplier to be evaluated, the question material may be divided into questions, and the questions may be automatically assigned a criterion ID 114b of the master data.

As an example of a method of automatic assignment, there is the following natural language processing, for example. First, in order to recognize commonality between questions, the answer support unit 122 uses, for example, various feature extraction methods such as Bag of Words, TF-IDF, BM-25, and N-gram alone or in combination, to generate an appropriate feature vector from a character string of a question. Further, the answer support unit 122 classifies the feature vectors generated from the question into the same class of feature vectors that can be regarded as having the same meaning of the original question, and assigns a classification ID thereto.

The answer support unit 122 trains a relationship between the feature vector and the classification ID in a plurality of patterns, and constructs a classifier capable of predicting the classification ID for a newly created feature vector from an unknown question. The classifier in the answer support unit 122 predicts the classification ID using, for example, a Support Vector Machine, a decision tree, or a k-nearest neighbor algorithm. That is, when the classifier determines that the classification ID is the same, the answer support unit 122 determines that questions have a common meaning.

Alternatively, a method of assigning each question a criterion ID 114b of the master data using artificial intelligence such as a neural network is also possible.

The answer receiving unit 123 determines whether there is an unanswered question (step S207). Specifically, the answer receiving unit 123 specifies, among the questions assigned to the master data in step S206, a question for which there is a shortage of answers (left unanswered) as an unanswered question.

If there is an unanswered question (“Yes” in step S207), the answer receiving unit 123 requests the supplier to complement the question (step S208). Specifically, the answer receiving unit 123 sends a message for requesting complementation to the supplier A computer 400, the supplier B computer 410, and the supplier C computer 420. Then, the answer receiving unit 123 returns control to step S205.

If there is no unanswered question (“No” in step S207), the evaluation unit 126 evaluates a company using the score allocation 114g in the master data set in step S201 (step S209). Specifically, the evaluation unit 126 evaluates the answer using the score allocation 114g and the marking criterion 114h in the master data to calculate the score 114i.

The comparison and analysis unit 127 organizes results of the evaluation in step S209 according to the criterion ID 114b for the supplier, and sends, to the evaluation requester, information showing comparative evaluations between the supplier companies (step S210).

The above is an example of the flowchart of the company evaluation processing. According to the company evaluation processing, even if a plurality of suppliers exist and a part or all of the suppliers are not under contract with an evaluation organization under contract with the evaluation requester, the evaluation requester can evaluate the suppliers.

In a case of a supplier that is not set as an evaluation target by any one of the evaluation organization and the buyer, if the supplier itself answers the question 114c of the master data 114, a result can be used to evaluate the supplier and compare the supplier with another supplier that is evaluated by the evaluation organization. In this way, even a supplier that is not an evaluation target by a buyer can use its own assessment sheet instead.

Further, it is also possible to evaluate a supplier by using only the question 114c of the master data 114, without using evaluation results of an evaluation organization and a buyer.

When only the question 114c of the master data 114 is used, answer support processing different from the answer support processing shown in FIG. 4 can be performed. FIG. 10 is another example of the process flow of the answer support processing. The answer support processing can be applied to both a survey agency and answerer assistance. FIG. 10 shows an example applied to the survey agency.

First, the answer support unit 122 sends the question 114c of the master data 114 to the supplier through the transmission interface 140 (step S301). The answer support unit 122 receives an answer to the question 114c of the master data 114, and a documentary evidence or data from the supplier through the transmission interface 140, and stores the answer, and the documentary evidence or the data in the master data storage area 113 (step S302).

The question material receiving unit 121 receives a question material from the evaluation organization or the buyer via the transmission interface 140 and saves the question material (step S303). Specifically, the question material receiving unit 121 receives the question material from the evaluation organization D computer 300, the evaluation organization E computer 310, the buyer F computer 800, and the buyer G computer 810. The question material receiving unit 121 breaks down the received question material into question units, reconstructs the question material, and stores the question material in the question material storage area 111 (FIG. 5).

For a question similar to any of the questions of the master data, the answer support unit 122 performs complementation by using an answer assigned to the master data and the documentary evidence or data to provide an answer to a question of a questionnaire of the evaluation organization and the documentary evidence or data (step S304).

The answer support unit 122 sends the question material from the evaluation organization and an answer proposal complemented in step S304 to the supplier through the transmission interface 140 (step S305).

The answer receiving unit 123 receives an answer from the supplier (step S306). Specifically, the answer receiving unit 123 receives an answer confirmed by the supplier, a documentary evidence or data, and a correction content of an answer proposal corrected as necessary via the transmission interface 140.

The learning and optimizing unit 125 saves the received answer as an answer history in the answer history storage area 112 (step S307) The learning and optimizing unit 125 analyzes a correction content of the answer proposal, and corrects a program that describes a procedure of creating the answer based on the documentary evidence or the data and a classifier of the learning and optimizing unit 125.

Then, the answer support unit 122 sends an answer received from the supplier to the evaluation organization or the buyer that requested the survey (step S308). Specifically, the answer support unit 122 sends the answer received from the supplier through the transmission interface 140 to the evaluation organization D computer 300, the evaluation organization E computer 310, the buyer F computer 800, and the buyer G computer 810.

According to the answer support processing described above, the supplier does not answer questions from the plurality of evaluation organizations and buyers every time, but can answer only the master data in advance. Therefore, the supplier can answer the questions of the plurality of evaluation organizations and the buyer only by confirming the answer proposal when there are questions from the plurality of evaluation organizations and the buyer.

When the above-described answer support processing is applied to the answerer assistance, the supplier receives a question material from the evaluation organization or the buyer in step S303. A difference is that in step S308, in the processing of sending the answer and the documentary evidence or the data to the evaluation organization or the buyer, the supplier itself sends the answer and the documentary evidence or the data. Even if there is a difference in a flow of sending and receiving the question materials, the question-answer and evaluation system 10 can reduce a burden of answering on the supplier.

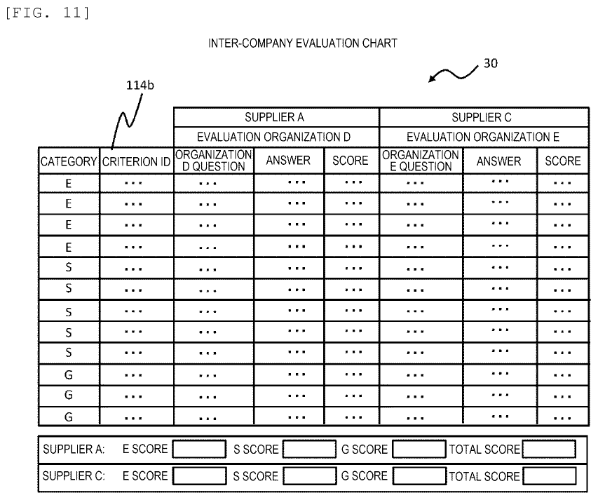

FIG. 11 is a diagram showing an example of an inter-company evaluation. In the present embodiment, the inter-company evaluation refers to side-by-side evaluations of different suppliers using different questions from different evaluation organizations or buyers. For example, in step S210, the comparison and analysis unit 127 outputs a table in which a horizontal axis indicates information (a set of a question, an answer, and a score) on a supplier and a vertical axis indicates the criterion ID 114b, that is, a question, as illustrated in an inter-company evaluation chart 30. In an example of the inter-company evaluation chart 30, the supplier A answers only a question from the evaluation organization D. On the other hand, the supplier C answers only a question from the evaluation organization E. There are one or more common questions of the evaluation organization D and the evaluation organization E, and by arranging the common questions side by side according to the criterion ID 114b, it is possible to conduct an inter-company evaluation of the supplier A and the supplier C by using answers to question from different evaluation organizations or buyers.

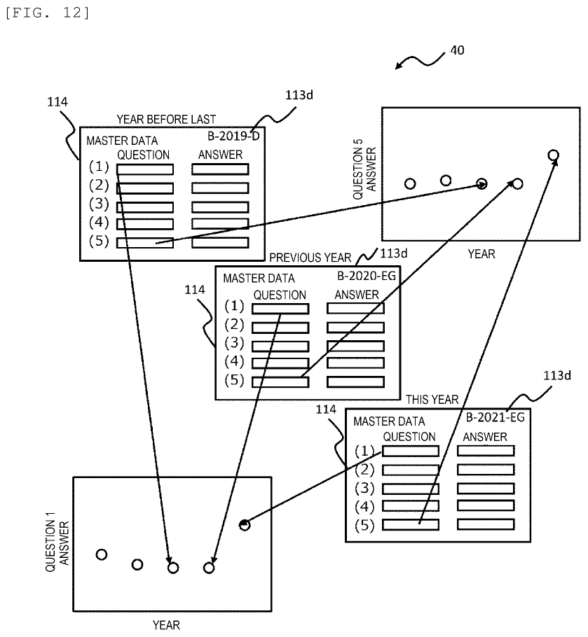

FIG. 12 is a diagram showing an example of performing factor analysis using master data. In FIG. 12, the master data 114 is illustrated in a simplified form. The criterion ID 114b is not basically deleted and is added as needed. Therefore, when receiving an instruction from a user, the comparison and analysis unit 127 follows an answer content of the same criterion ID 114b stored in the master data 114 for each answer period in time series. The comparison and analysis unit 127 analyzes a factor of a change over time in the answer content for the specific criterion ID 114b based on a correlation with a variation of answer data for another criterion ID 114b.

At this time, the number of criterion ID 114b used by the comparison and analysis unit 127 for analysis may be one or more. For example, when a question to be analyzed is a CO₂ emission amount, the comparison and analysis unit 127 analyzes a factor by considering correlations with changes in questions related to the number of employees, sales, a recycled material usage rate, an emission intensity used for calculation, and whether reduction measures are implemented. A graph 40 in FIG. 12 is an example of a case where answers to the question to be analyzed and a related question are numerical values. However, the invention is not limited to such an example. It is possible that either or both of the answers to the question to be analyzed and the related question may not be numerical values, for example, regarding presence or absence of measures or policies implemented by a company. A transition of an answer result shown in the graph of FIG. 12 is sent from the processor system 100 to screens of computers of an evaluation requester who is a user, a supplier himself or herself, or another user, and can be viewed.

At this time, the master data 114 is created by integrating questionnaires provided by a plurality of evaluation organizations and a questionnaire independently generated by a buyer. Therefore, even if an evaluation requester (such as a buyer or a supplier who wants to evaluate his and her ESG status) joins an evaluation organization in the middle, or if the evaluation requester changes an evaluation organization with which evaluation requester contracts in the middle, a transition for each evaluation period can be evaluated on the same time-series data. For example, the master data ID 113d of each master data 114 illustrated in FIG. 12 corresponds to the master data ID 113d with the answer period 113b from 2019 to 2021 at the supplier B. Although the supplier B has a different questionnaire issuing organization ID 113c for the answer period 2019 and for 2020 and after, the comparison and analysis unit 127 integrates questionnaires with questions of the master data 114 to conduct an evaluation as a series of time-series data.

According to the invention, even if a part or all of a plurality of suppliers do not have a contract with an evaluation organization contracted by a buyer, the buyer can evaluate the suppliers. Further, since the supplier can automatically answer a questionnaire only by attaching a documentary evidence or data to a specific question or collecting a documentary evidence or data via a supplier computer, a burden of answering on the supplier can be reduced in the present technology. Further, in the present technology, by using master data unique to the supplier, it is possible to analyze a factor of a variation in the answer content for a specific question, and to facilitate supplier evaluation and management for the buyer.

The processor system 100 has a function of performing machine learning on a relationship between answer information to a question and a documentary evidence or data that supports the answer information, and automatically inputting an answer to the question by attaching the documentary evidence or data that supports the answer information or collecting a document or data via a supplier computer. At this time, the documentary evidence or data that supports the answer information may be an electronic document, or may be data obtained by digitizing a handwritten document using image recognition, PDF, or the like. A format of the documentary evidence or data corresponds to any of a document such as PDF, numerical data written in a CSV file or the like, numerical data directly acquired from facilities and equipment owned by a supplier collected via the supplier computer, information obtained from Web information by Web crawling or the like, and the like.

Further, in the processor system 100, the master data exists for each supplier and for each evaluation period, and by using the master data unique to the supplier, a factor of an answer result to the supplier to a specific question is specified by correlation analysis with an answer result to another question related to the specific question. Since the master data 114 is created by integrating questionnaires provided by a plurality of evaluation organizations and a questionnaire independently created by a buyer, it is possible to evaluate a transition for each evaluation period in time series, even if a buyer joins an evaluation organization in the middle, or if a buyer changes an evaluation organization with which the buyer contracts in the middle.

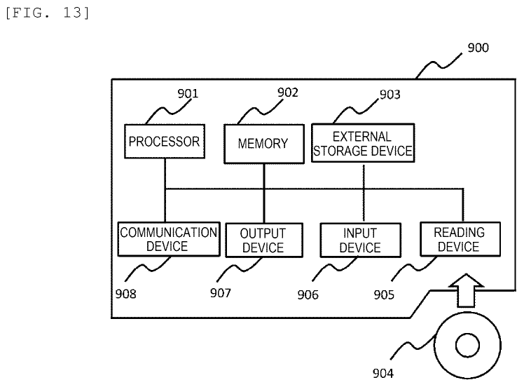

FIG. 13 is a diagram showing an example of a hardware structure of the processor system. The processor system 100 can be implemented by a general computer 900 including a processor (for example, a central processing unit (CPU) or a graphics processing unit (GPU)) 901, a hardware memory 902 such as a random access memory (RAM), an external storage device 903 such as a hard disk drive (HDD) or a solid state drive (SSD), a reading device 905 that reads information from a portable storage medium 904 such as a compact disk (CD) or a digital versatile disk (DVD), an input device 906 such as a keyboard, a mouse, a barcode reader, or a touch panel, an output device 907 such as a display, and a communication device 908 that communicates with other computers via a communication network such as a LAN or the Internet, or a network system including a plurality of the computers 900. The reading device 905 may be capable of not only reading from but also writing to the portable storage medium 904.

The processor 901 executes various types of processing by executing various predetermined programs loaded from the external storage device 903 to the memory 902. The program is, for example, an application program that can be executed on an operating system (OS) program. For example, the program may be installed in the external storage device 903 from the portable storage medium 904 via the reading device 905, or may be downloaded from a network via the communication device 908 and executed by the processor 901.

For example, the question material receiving unit 121, the answer support unit 122, the answer receiving unit 123, the evidence data processing unit 124, the learning and optimizing unit 125, the evaluation unit 126, and the comparison and analysis unit 127 can be implemented by loading a program stored in the external storage device 903 into the memory 902 and executing the program by the processor 901. The input and output interface 130 can be implemented by the processor 901 using the input device 906, the output device 907, and the communication device 908. The memory 110 can be implemented by the processor 901 using the memory 902 or the external storage device 903. The transmission interface 140 can be implemented by the processor 901 using the communication device 908.

The above is an example of the question-answer and evaluation system according to the embodiment of the invention. The invention is not limited to the embodiments described above, and includes various modifications. For example, the above-described embodiments have been described in detail to facilitate understanding of the invention, and the invention is not necessarily limited to those including all the configurations described above. A part of a configuration according to a certain embodiment can be replaced with a configuration according to another embodiment, and a configuration according to another embodiment can be added to a configuration according to a certain embodiment. It is also possible to delete a part of the configuration of the embodiment.

Some or all of the above units, configurations, functions, processing units, and the like described above may be implemented by hardware by, for example, designing with an integrated circuit. The above units, configurations, functions, and the like may be implemented by software by a processor interpreting and executing a program for implementing the functions. Information such as a program, a table, and a file for implementing the functions can be stored in a recording device such as a memory or a hard disk, or a recording medium such as an IC card, an SD card, and a DVD.

Control lines and information lines according to the embodiments described above are considered to be necessary for description, and not all the control lines and the information lines on the product are necessarily shown. Actually, almost all configurations may be considered to be connected. The embodiments of the invention have been mainly described above.

### REFERENCE SIGNS LIST

10: question-answer and evaluation system
50: network
100: processor system
110: memory
111: question material storage area
112: answer history storage area
113: master data storage area
114: master data
120: processing unit
121: question material receiving unit
122: answer support unit
123: answer receiving unit
124: evidence data processing unit
125: learning and optimizing unit
126: evaluation unit
127: comparison and analysis unit
130: input and output interface
140: transmission interface
300: evaluation organization D computer
310: evaluation organization E computer
400: supplier A computer
410: supplier B computer
420: supplier C computer
800: buyer F computer
810: buyer G computer
850: evaluation requester H computer

1. A company evaluation processor system comprising:
one or more memories; and
one or more processors, wherein
the memory stores, for each predetermined target company, master data in which at least one or more questions are associated with an answer to the question, and stores a predetermined score allocation associated with each question in the master data for each evaluation company that evaluates the target company, and
the processor
receives a questionnaire acquired by the target company from a questionnaire distribution source and a questionnaire answer, which is an answer of the target company to a questionnaire question that is one or more questions in the questionnaire,
when any of the questionnaire questions and any of the questions in the master data related to the target company are similar to each other, stores the questionnaire answer in the memory as the answer in the master data related to the target company, and
scores the answer in the master data of the target company using the score allocation according to the evaluation company to evaluate the target company and output the evaluation.

2. The company evaluation processor system according to claim 1, wherein
the processor
receives a second questionnaire acquired by a second target company different from the target company from the questionnaire distribution source or a second questionnaire distribution source different from the questionnaire distribution source, and a second questionnaire answer of the second target company to a second questionnaire question that is one or more questions in the second questionnaire,
when any of the second questionnaire questions and any of the questions in the master data related to the second target company are similar to each other, stores the second questionnaire answer in the memory as the answer in the master data related to the second target company, and
scores the answer in the master data of the target company and the answer in the master data of the second target company using the score allocation according to the evaluation company, and outputs evaluations for the target company and the second target company in a comparable manner.

3. The company evaluation processor system according to claim 1, wherein
the processor
receives a data set related to the questionnaire answer, and
reads out one or more pieces of data at a predetermined position in the data set, and uses the one or more pieces of data to complement the questionnaire answer.

4. The company evaluation processor system according to claim 1, wherein
the processor selectively receives one of a plurality of predetermined score allocation proposals from the evaluation company and stores the score allocation proposal as the score allocation in the memory, or receives an input of the score allocation from the evaluation company and stores the score allocation in the memory.

5. The company evaluation processor system according to claim 1, wherein
the processor
receives a second questionnaire that the target company acquires from a second questionnaire distribution source different from the questionnaire distribution source, and
when any of the second questionnaire questions that are one or more questions in the second questionnaire and any of the questions in the master data related to the target company are similar to each other, sets the answer in the master data related to the target company as an answer to the second questionnaire question.

6. The company evaluation processor system according to claim 1, wherein
the memory stores the master data for each predetermined period for each predetermined target company, and
the processor performs correlation analysis among a plurality of questions with respect to a change over time in the answer related to numerical data among the answers of the target companies during the period, performs factor analysis, and presents a result to the target company.

7. A company evaluation processor system comprising:
one or more memories; and
one or more processors, wherein
the memory stores, for each predetermined target company, master data in which at least one or more questions are associated with an answer to the question, and
the processor
sends the master data to the target company,
receives an answer to each question in the master data from the target company and a data set related to the answer, and
when the target company receives a questionnaire acquired from a questionnaire distribution source, sets the answer to the master data related to the target company and the related data set as an answer to a questionnaire question in a case where any of the questionnaire questions that are one or more questions in the questionnaire and any of the questions in the master data related to the target company are similar to each other.

8. The company evaluation processor system according to claim 7, wherein
the processor reads out one or more pieces of data at a predetermined position in the related data set and uses the one or more pieces of data to complement an answer to the questionnaire question.

9. A company evaluation processor system comprising:
one or more memories; and
one or more processors, wherein
the memory stores, for each predetermined target company, master data in which at least one or more questions are associated with an answer to the question, and
the processor
receives a questionnaire acquired by the target company from a questionnaire distribution source, a questionnaire answer that is an answer of the target company to a questionnaire question that is one or more questions in the questionnaire, and a data set related to the questionnaire answer, and
reads out one or more pieces of data at a predetermined position in the data set and uses the one or more pieces of data to complement the questionnaire answer.

10. The company evaluation processor system according to claim 9, wherein
the processor selects an answer from one or more predetermined answer proposals according to one or more pieces of data read at a predetermined position in the data set and performs the complementation.

11. The company evaluation processor system according to claim 9, wherein
the memory stores a predetermined calculation formula having a plurality of input variables, and
the processor extracts a plurality of pieces of data read at a predetermined position in the data set, uses the extracted data as the input variables, performs a calculation using the calculation formula, and uses a result to complement the questionnaire answer.

12. The company evaluation processor system according to claim 9, wherein
the memory stores a predetermined calculation formula having a plurality of input variables, and
the processor extracts a plurality of pieces of data read at a predetermined position in the data set and uses the extracted data as the input variables, and also uses external data collected by crawling processing as the input variables to perform a calculation using the calculation formula and uses a result to complement the questionnaire answer.

13. The company evaluation processor system according to claim 9, wherein
the data set is data sent from the target company or data sent from a predetermined computer of the target company for each predetermined period.

14. The company evaluation processor system according to claim 9, wherein
the processor
performs machine learning using presence or absence of a correction to the questionnaire answer and corrected answer information to construct a trained model for each of the target companies, and
uses the trained model in processing of complementing a second questionnaire answer of the target company to a second questionnaire in which any one or more of a survey period and the questionnaire distribution source are different from a survey period and the questionnaire distribution source of the questionnaire.

15. The company evaluation processor system according to claim 9, wherein
the processor outputs a message indicating that the data set is insufficient as documentary evidence if the data set includes the data whose creation date is before an evaluation target period.

16. The company evaluation processor system according to claim 1, wherein
at least one of the questions in the master data is a question of non-financial information related to management.
